(19) United States
(12) Patent Application Publication
(10) Pub. No.: US 2019/0392981 A1
(43) Pub. Date: Dec. 26, 2019

(54) THREE-DIMENSIONAL WOUND CORE OPEN DRY-TYPE TRANSFORMER COIL STRUCTURE AND WINDING METHOD THEREFOR

(71) Applicant: Haihong Electric Co., Ltd., Kaiping (CN)

(72) Inventors: Kaixuan Xu, Kaiping (CN); Lizhen Zhai, Kaiping (CN); Qingning Liang, Kaiping (CN); Jingtao Luo, Kaiping (CN); Libo Zhou, Kaiping (CN)

(21) Appl. No.: 16/483,993

(22) PCT Filed: Nov. 24, 2017
(86) PCT No.: PCT/CN2017/112734

§ 371 Date: Aug. 6, 2019

(30) Foreign Application Priority Data
Jun. 23, 2017 (CN) 201710484148.0

(51) Int. Cl. H01F 27/32; H01F 27/30; H01F 27/28; H01F 27/29; H01F 41/066

(52) U.S. Cl. CPC H01F 27/324; H01F 27/306; H01F 27/2876; H01F 27/29; H01F 41/066; H01F 27/2823

(57) ABSTRACT

A three-dimensional wound core open dry-type transformer coil structure and a winding method therefor. The three-dimensional wound core open dry-type transformer coil structure comprises a three-dimensional wound core, an insulating cylinder disposed outside the three-dimensional wound core, and a coil winding wound onto the insulating cylinder. The coil winding is formed by winding insulating wires; comb-shaped supporting bars are uniformly disposed outside the insulating cylinder; the insulating wires are wound between racks of the comb-shaped supporting bars; coil taps are connected to the coil winding; the coil taps are led out onto a surface of the coil winding; a head end of the coil winding and a part of the coil winding leading out the coil taps are wound into a forward and reverse hybrid coil; and the remaining parts are wound into a fully forward coil.

### FIELD

The present disclosure relates to the field of power equipment technologies, and more particularly, to a transformer coil structure and a winding method therefor.

### BACKGROUND

At present, the advantages of three-dimensional wound core open dry-type transformer products have been affirmed by the majority of users. However, a fully forward continuous structure is mainly employed in the traditional three-dimensional wound core open dry-type transformer coil, which causes a head, a tail and a tap of a coil to have to be led out from an inside of the coil, thus increasing the operation difficulty of the tap part, being complicated in process, greatly limiting a production efficiency, increasing manufacturing costs, and reducing a safety of a transformer during operation. There are a lot of parallel wound wires especially when the coil has a large current, and it is difficult to lead out the head from the inside of the coil, thus limiting an application range of the coil structure, and making the coil structure be only applicable to coils of a small current transformer, so that the coil structure lacks a market competitiveness. In addition, a large number of cushion block materials need to be consumed since inner diameter supporting bars and inter-segment insulating cushion blocks are used in the existing coil. Moreover, surface for heat dissipation of the coil is small due to a large contact area between insulating wires and the cushion blocks in the traditional structure, thus significantly limiting the heat dissipation capability of the coil. Therefore, it is necessary to improve and optimize the existing three-dimensional wound core open dry-type transformer coil and the winding method therefor.

### SUMMARY

In order to overcome the defects of the prior art, the present disclosure provides a novel three-dimensional wound core open dry-type transformer coil structure which includes a forward coil and a forward and reverse alternating coil, so as to optimize the structure, reduce the cost, improve the production efficiency, and widen the application range of the coil. Meanwhile, a method for winding the coil structure is provided to simplify the process and improve the production efficiency.

The technical solutions employed by the present disclosure to solve the technical problems thereof are as follows.

There is provided a three-dimensional wound core open dry-type transformer coil structure comprising a three-dimensional wound core, an insulating cylinder disposed outside the three-dimensional wound core, and a coil winding wound onto the insulating cylinder, the coil winding is formed by winding insulating wires, the insulating cylinder is provided uniformly with comb-shaped supporting bars at an outer side, the insulating wires are wound between racks of the comb-shaped supporting bars, the coil winding is connected with coil taps which are led out onto a surface of the coil winding, a head end of the coil winding and a part of the coil winding leading out the coil taps are wound into a forward and reverse hybrid coil, and remaining parts are wound into a fully forward coil.

The coil winding comprises a plurality of wire turns connected by transpositional connecting wires, each wire turn is disposed between two racks of the comb-shaped supporting bars, the forward and reverse hybrid coil comprises forward wire turns and reverse wire turns which are alternately wound, and the transpositional connecting wire of each set of forward wire turns and reverse wire turns is located on a surface of the forward and reverse hybrid coil; and the fully forward coil comprises a plurality of forward wire turns, and the transpositional connecting wire between two adjacent forward wire turns is connected from a surface of one turn to an inner ring of another turn.

The forward wire turns are continuously wound from inside to outside perpendicular to the insulating cylinder, and the reverse wire turns are continuously wound from inside to outside perpendicular to the insulating cylinder and in an opposite direction to the forward wire turns.

The insulating wires are single-strand wires or multi-strand parallel-wound wires arranged according to actual needs.

The comb-shaped supporting bars are adhered to the outer side of the insulating cylinder, the racks of the comb-shaped supporting bars face outward, and the corresponding racks of all the comb-shaped supporting bars are placed at a same height.

The comb-shaped supporting bars are made of insulating materials.

There is provided a winding method for a three-dimensional wound core open dry-type transformer coil, comprising arranging an insulating cylinder outside a three-dimensional wound core and winding a coil winding with insulating wires onto the insulating cylinder, the winding method comprises the following steps of:

a. uniformly adhering comb-shaped supporting bars outside the insulating cylinder, and winding wire turns with the insulating wires between racks of comb-shaped supporting bars;

b. winding the coil winding from bottom to top, comprising: winding a reverse wire turn between two racks at a lowest layer of the comb-shaped supporting bars firstly, so that an initial wire head is disposed on a surface of the reverse wire turn, and then winding a fully forward coil comprising a plurality of forward wire turns upwardly in sequence; and

c. winding a forward and reverse hybrid coil at a part needing to lead out coil taps, and leading out the coil taps at transpositional connecting wires of each set of forward wire turns and reverse wire turns of the forward and reverse hybrid coil.

A temporary forward-segment wire turn is firstly wound before winding the reverse wire turns, and the temporary forward wire turn is flipped and overlaid between the racks of a designated comb-shaped supporting bar sequentially from outside to inside, and tensioned to form a reverse wire turn.

The fully forward coil is continuously wound after the forward and reverse hybrid coil is completely wound, and each forward wire turn is wound sequentially from inside to outside.

The present disclosure has the beneficial effects that: by using the comb-shaped supporting bars, each turn of the insulating wire is directly wound between the racks of the comb-shaped supporting bars, and the inner diameter supporting bars and inter-segment insulating cushion blocks used in the existing coils are eliminated, so that a large number of cushion block materials are saved. Because a contact area between the comb-shaped supporting bar and the insulating wire is much smaller than that between the insulating wire and the cushion block in the traditional structure, the coil has a larger heat dissipation surface under the same coil volume, so that the heat dissipation capability of the coil is greatly improved. By manufacturing the coil winding as a continuous coil structure combining the fully forward coil and the forward and reverse hybrid coil, all the heads, tails and taps of the coil are ensured to be directly led out from the surface of the coil, so that the process complexity due to leading some coil taps out of interior of the coil in the existing structure can be avoided, and the production efficiency and the operation safety of the transformer are improved. In addition, since all the heads, tails and taps of the coil are directly led out from the surface of the coil, the transformer coil structure can be effectively optimized, the manufacturing difficulty and costs can be reduced, and the market competitiveness of the transformer can be improved, so that the coil has a wider application range, can meet the needs of the transformer coil structures with various capacities, and has more prominent advantages especially when being used for high-current products.

### BRIEF DESCRIPTION OF THE DRAWINGS

The present disclosure is further described below with reference to the drawings and the embodiments.

FIG. 1 is an expanded view of a coil winding structure according to the present disclosure; and

FIG. 2 is a side view showing the structure of a comb-shaped supporting bar according to the present disclosure.

### DETAILED DESCRIPTION OF THE EMBODIMENTS

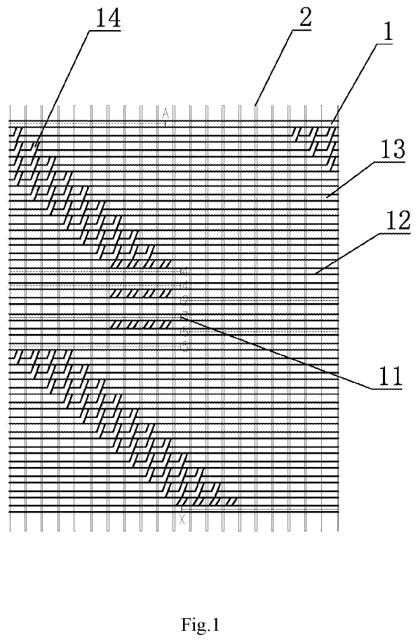

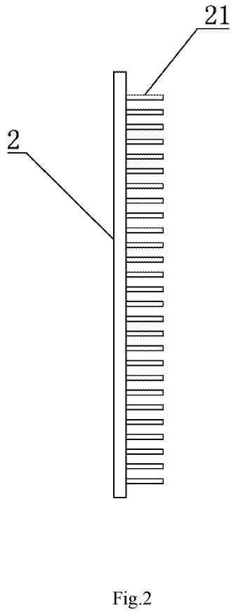

With reference to FIGS. 1 to 2, a three-dimensional wound core open dry-type transformer coil structure according to the present disclosure comprises a three-dimensional wound core, an insulating cylinder disposed outside the three-dimensional wound core, and a coil winding wound onto the insulating cylinder and formed by winding insulating wires 1. The insulating cylinder is uniformly adhered with comb-shaped supporting bars 2 outside, and racks 21 of each of the comb-shaped supporting bars 2 face outward. The corresponding racks 21 of all the comb-shaped supporting bars 2 are placed at a same height, so that the insulating wires 1 are wound into a plurality of wire turns layer by layer from bottom to top. The comb-shaped supporting bars 2 are made of insulating materials. By using the comb-shaped supporting bars, each turn of the insulating wires is directly wound between the racks of the comb-shaped supporting bars, and inner diameter supporting bars and inter-segment insulating cushion blocks used in the existing coil are eliminated, so that a large number of cushion block materials are saved. Because a contact area between the comb-shaped supporting bar and the insulating wire is much smaller than that between the insulating wire and the cushion block in the traditional structure, the coil has a larger heat dissipation surface under the same coil volume, so that the heat dissipation capability of the coil is greatly improved. The insulating wires 1 are single-strand wires or multi-strand parallel-wound wires disposed according to actual needs, so as to meet the needs of the transformers with different current magnitudes.

The insulating wires 1 are wound between the racks 21 of the comb-shaped supporting bars 2, the coil winding is connected with coil taps 11 which are led out onto a surface of the coil winding, a head end of the coil winding and a part of the coil winding leading out the coil taps 11 are wound into a forward and reverse hybrid coil 12, and the remaining parts are wound into a fully forward coil 13. By manufacturing the coil winding into a continuous coil structure combining the fully forward coil and the forward and reverse hybrid coil, all the heads, tails and taps of the coil are ensured to be directly led out from a surface of the coil, and the process complexity due to leading some coil taps out of interior of the coil in the existing structure can be avoided, and the production efficiency and the operation safety of the transformer are improved. In addition, since all the heads and tails of the coil and the coil taps are directly led out from the surface of the coil, the transformer coil structure can be effectively optimized, the manufacturing difficulty and costs can be reduced, and the market competitiveness of the transformer can be improved, so that the coil has a wider application range, can meet the needs of the transformer coil structures with various capacities, and has more prominent advantages especially when being used for high-current products.

The coil winding comprises a plurality of wire turns connected by transpositional connecting wires 14, each wire turn is disposed between two racks 21 of the comb-shaped supporting bars 2. The forward and reverse hybrid coil 12 comprises forward wire turns and reverse wire turns which are alternately wound, the transpositional connecting wires 14 of each set of forward wire turns and reverse wire turns are located on a surface of the forward and reverse hybrid coil 12, and the coil taps 11 are led out at the transpositional connecting wires 14. The fully forward coil 13 comprises a plurality of forward wire turns, and the transpositional connecting wires 14 between two adjacent forward wire turns are connected from a surface of one turn to an inner ring of another turn. The forward wire turns are continuously wound from inside to outside perpendicular to the insulating cylinder, and the reverse wire turns are continuously wound from inside to outside perpendicular to the insulating cylinder and in an opposite direction to the forward wire turns. Since all the coil taps are directly led out from the surface of the coil, an operation process is greatly simplified, and a potential safety hazard and a process complexity due to leading of some coil taps out of interior of the coil in the existing structure can be avoided.

The winding process of the coil according to the present disclosure is as follows.

Arranging an insulating cylinder outside a three-dimensional wound core, adhering comb-shaped supporting bars 2 uniformly outside the insulating cylinder, and winding wire turns with insulating wires 1 between racks 21 of the comb-shaped supporting bars 2 to form a coil winding.

The coil winding is wound from bottom to top, a reverse wire turn is wound between two racks 21 at a lowest layer of the comb-shaped supporting bar 2 firstly, so that an initial wire head is disposed on a surface of the reverse wire turn. A temporary forward wire turn is wound before winding the reverse wire turn, and then the temporary forward wire turn is flipped and overlaid between the racks 21 of the designated comb-shaped supporting bar 2 sequentially from outside to inside, and tensioned to form the reverse wire turn.

The fully forward coil 13 comprising a plurality of forward wire turns are wound upwardly in sequence after the reverse wire turn at the lowest layer is completely wound, each forward wire turn is wound sequentially from inside to outside, and the transpositional connecting wires 14 between two adjacent forward wire turns are connected from an outer ring of the lower turn to an inner ring of the upper turn.

Forward and reverse hybrid coil 12 is wound when the fully forward coil 13 is wound at a part needing to lead out coil taps 11. Number of sets of forward wire turns and reverse wire turns of the forward and reverse hybrid coil 12 is determined according to a number of the coil taps to be led out. The forward wire turns in each set of forward wire turns and reverse wire turns are located below, and the reverse wire turns in each set of forward wire turns and reverse wire turns are located above, the transpositional connecting wires 14 are disposed outside the coil, and the coil taps 11 are led out at the transpositional connecting wires 14.

The fully forward coil 13 is continuously wound after the forward and reverse hybrid coil 12 is completely wound, until the coil winding is completely wound. The uppermost wire turn is the forward wire turn, and heads of the insulating wires are still disposed outside the coil.

The above is only the preferred embodiments of the disclosure, but the disclosure is not limited to the above embodiments, and the technical solution which can achieve the technical effects of the disclosure by any same or similar means shall fall within the protection scope of the invention.

1. A three-dimensional wound core open dry-type transformer coil structure, comprising a three-dimensional wound core, an insulating cylinder disposed outside the three-dimensional wound core, and a coil winding wound onto the insulating cylinder, the coil winding is formed by winding insulating wires, wherein the insulating cylinder is provided uniformly with comb-shaped supporting bars at an outer side, the insulating wires are wound between racks of the comb-shaped supporting bars, the coil winding is connected with coil taps which are led out onto a surface of the coil winding, a head end of the coil winding and a part of the coil winding leading out the coil taps are wound into a forward and reverse hybrid coil, and remaining parts are wound into a fully forward coil.

2. The three-dimensional wound core open dry-type transformer coil structure as claimed in claim 1, wherein the coil winding comprises a plurality of wire turns connected by transpositional connecting wires, each wire turn is disposed between two racks of the comb-shaped supporting bars, the forward and reverse hybrid coil comprises forward wire turns and reverse wire turns which are alternately wound, and the transpositional connecting wire of each set of forward wire turns and reverse wire turns is located on a surface of the forward and reverse hybrid coil; and the fully forward coil comprises a plurality of forward wire turns, and the transpositional connecting wire between two adjacent forward wire turns is connected from a surface of one turn to an inner ring of another turn.

3. The three-dimensional wound core open dry-type transformer coil structure as claimed in claim 2, wherein the forward wire turns are continuously wound from inside to outside perpendicular to the insulating cylinder, and the reverse wire turns are continuously wound from inside to outside perpendicular to the insulating cylinder and in an opposite direction to the forward wire turns.

4. The three-dimensional wound core open dry-type transformer coil structure as claimed in claim 1, wherein the insulating wires are single-strand wires or multi-strand parallel-wound wires arranged according to actual needs.

5. The three-dimensional wound core open dry-type transformer coil structure as claimed in claim 1, wherein the comb-shaped supporting bars are adhered to the outer side of the insulating cylinder, the racks of the comb-shaped supporting bars face outward, and the corresponding racks of all the comb-shaped supporting bars are placed at a same height.

6. The three-dimensional wound core open dry-type transformer coil structure as claimed in claim 5, wherein the comb-shaped supporting bars are made of insulating materials.

7. A winding method for a three-dimensional wound core open dry-type transformer coil, comprising arranging an insulating cylinder outside a three-dimensional wound core and winding a coil winding with insulating wires onto the insulating cylinder, wherein the winding method comprises the following steps of:
a. uniformly adhering comb-shaped supporting bars outside the insulating cylinder, and winding wire turns with the insulating wires between racks of comb-shaped supporting bars;
b. winding the coil winding from bottom to top, comprising: winding a reverse wire turn between two racks at a lowest layer of the comb-shaped supporting bars firstly, so that an initial wire head is disposed on a surface of the reverse wire turn, and then winding a fully forward coil comprising a plurality of forward wire turns upwardly in sequence; and
c. winding a forward and reverse hybrid coil at a part needing to lead out coil taps, and leading out the coil taps at transpositional connecting wires of each set of forward wire turns and reverse wire turns of the forward and reverse hybrid coil.

8. The winding method for a three-dimensional wound core open dry-type transformer coil as claimed in claim 7, wherein a temporary forward-segment wire turn is firstly wound before winding the reverse wire turns, and the temporary forward wire turn is flipped and overlaid between the racks of a designated comb-shaped supporting bar sequentially from outside to inside, and tensioned to form a reverse wire turn.

9. The winding method for a three-dimensional wound core open dry-type transformer coil as claimed in claim 8, wherein the fully forward coil is continuously wound after the forward and reverse hybrid coil is completely wound, and each forward wire turn is wound sequentially from inside to outside.
